(19) United States
(12) Patent Application Publication
(10) Pub. No.: US 2014/0315478 A1
(43) Pub. Date: Oct. 23, 2014

(54) AIR VENT DEVICE OF VEHICLE

(71) Applicant: Hyundai Mobis Co., Ltd., Yongin-si (KR)

(72) Inventor: Ki Yeong Kim, Yongin-si (KR)

(73) Assignee: HYUNDAI MOBIS Co., Ltd., Yongin-si (KR)

(21) Appl. No.: 14/089,820

(22) Filed: Nov. 26, 2013

(30) Foreign Application Priority Data
Apr. 23, 2013 (KR) 10-2013-0044981

(51) Int. Cl. B60H 1/34

(52) U.S. Cl. CPC B60H 1/3421
USPC 454/155

(57) ABSTRACT

The present invention relates to an air vent device of a vehicle, including: a damper door which adjusts a flow rate of air that is supplied to the interior of the vehicle; a knob which is provided to operate the damper door; and an operating member which connects the damper door and the knob, in which the operating member includes: a link portion connected to the damper door; a rod portion connected to the knob; and a connecting portion which is connected between the link portion and the rod portion, and is formed to be bent or rotated, in which the link portion, the rod portion, and the connecting portion are integrally formed by injection molding.

### CROSS-REFERENCE TO RELATED APPLICATIONS

The present application claims priority to Korean Patent Application Number 10-2013-0044981 filed Apr. 23, 2013, the entire contents of which the application is incorporated herein for all purposes by this reference.

### TECHNICAL FIELD

The present invention relates to an air vent device of a vehicle, and more particularly, to an operating member which is connected between a damper door and a knob that are included in an air vent device of a vehicle.

### BACKGROUND

An air conditioning system is mounted in a vehicle in order to adjust a temperature in the interior of the vehicle in accordance with the season, and cold air or warm air generated in the air conditioning system flow into an air vent through an instrument panel, and are discharged to the interior of the vehicle.

An air vent device is provided in the air vent in order to adjust a flow direction and a flow rate of cold air or warm air that is generated in the air conditioning system.

The air vent device includes a damper door in order to adjust a flow direction of cold air or warm air that flows into the interior of the vehicle.

Cold air or warm air is discharged into the vehicle while a flow direction of cold air or warm air is adjusted by a wing assembly installed in the air vent.

As illustrated in FIG. 2, an air vent device according to the related art includes a four-bar link mechanism having a damper door 1, a link 2, a rod 3, and a knob 4. In the four-bar link mechanism, when the knob 4 is operated, the rod 3 is linearly moved, the link 2 is rotated, and thereby, an opening and closing angle of the damper door 1 is adjusted. However, the air vent device of a vehicle according to the related art has problems in that inappropriate gaps are formed between components due to the large number of components, or components are erroneously assembled, which causes operational failure.

### SUMMARY

The present invention has been made in an effort to provide an air vent device having a simple structure.

Technical problems of the present invention are not limited to the aforementioned technical problems, and other technical problems, which are not mentioned above, may be clearly understood by those skilled in the art from the following descriptions.

An exemplary embodiment of the present invention provides an air vent device of a vehicle, including: a damper door which adjusts a flow rate of air that is supplied to the interior of the vehicle; a knob which is provided to operate the damper door; and an operating member which connects the damper door and the knob, in which the operating member includes: a link portion connected to the damper door; a rod portion connected to the knob; and a connecting portion which is connected between the link portion and the rod portion, and is formed to be bent or rotated, in which the link portion, the rod portion, and the connecting portion are integrally formed by injection molding.

The connecting portion, one side portion of the link portion, and one side portion of the rod portion may be coated with an elastic member by insert injection molding using an elastic material such as rubber.

A thickness of the one side portion of the link portion and/or a thickness of the one side portion of the rod portion may be gradually decreased toward the connecting portion.

A portion of the one side portion of the rod portion, which is coated with a synthetic resin and disposed to be opposite to the connecting portion, may have a thickness the same as a thickness of the adjacent rod portion, and a portion of the one side portion of the link portion, which is coated with the synthetic resin and disposed to be opposite to the connecting portion, may have a thickness the same as a thickness of the adjacent link portion.

A width in front and rear directions of the connecting portion, which is coated with a synthetic resin, may be smaller than a width in front and rear directions of the one side portion which is coated with a synthetic resin.

A cross section of the connecting portion may be formed in a circular shape, and a thickness of the connecting portion may be smaller than thicknesses of the link portion and the rod portion.

The link portion may be longer than the connecting portion, and the rod portion may be longer than the link portion.

Specific items of other embodiments are included in the detailed description and the drawings.

According to the air vent device of a vehicle of the present invention, components are integrated such that it is not necessary to manage dimensions of ball joints that are matching portions between the components, the rod portion and the link portion are not moved away when conveyed or assembled, the components are integrated such that an accurate operational angle may be implemented, stability of dimension is improved, and noise and air leakage are not generated, thereby improving convenience.

The effects of the present invention are not limited to the aforementioned effects, and other effects, which are not mentioned above, will be clearly understood by those skilled in the art from the claims.

### BRIEF DESCRIPTION OF THE DRAWINGS

FIG. 1 is a perspective view illustrating a typical air vent device of a vehicle.

FIG. 2 is a front view illustrating an air vent device of a vehicle according to the related art.

FIG. 3 is a front view illustrating an air vent device of a vehicle according to an exemplary embodiment of the present invention.

FIGS. 4A and 4B are front views illustrating steps of manufacturing an operating member illustrated in FIG. 3.

FIG. 4C is a partially enlarged view of FIG. 4B.

FIGS. 5A and 5B are explanatory views illustrating operational states of the operating member illustrated in FIG. 3.

FIG. 6 is a partially enlarged view of the operating member illustrated in FIG. 3.

FIG. 7 is an enlarged cross-sectional view taken along line A-A′ of FIG. 3.

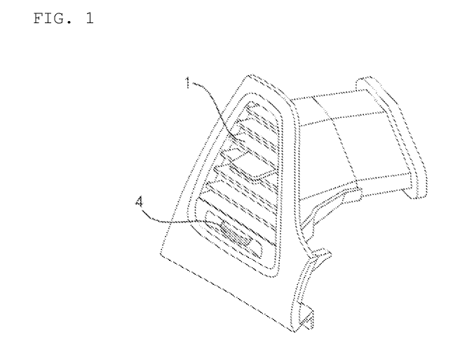

### DETAILED DESCRIPTION

Advantages and features of the present invention and methods of achieving the advantages and features will be clear with reference to exemplary embodiments described in detail below together with the accompanying drawings. However, the present invention is not limited to the exemplary embodiments set forth below, and may be embodied in various other forms. The present exemplary embodiments are for rendering the description of the present invention complete and are set forth to provide a complete understanding of the scope of the invention to a person with ordinary skill in the technical field to which the present invention pertains, and the present invention will only be defined by the scope of the claims. Like reference numerals indicate like elements throughout the specification.

Hereinafter, the present invention will be described with reference to the drawings in which the exemplary embodiments of the present invention are illustrated.

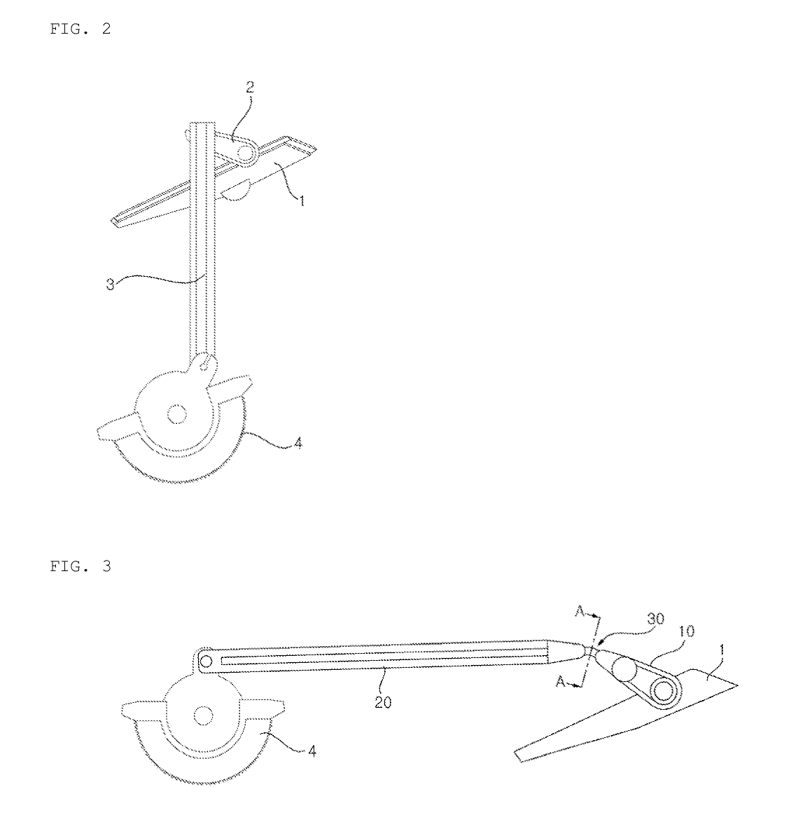

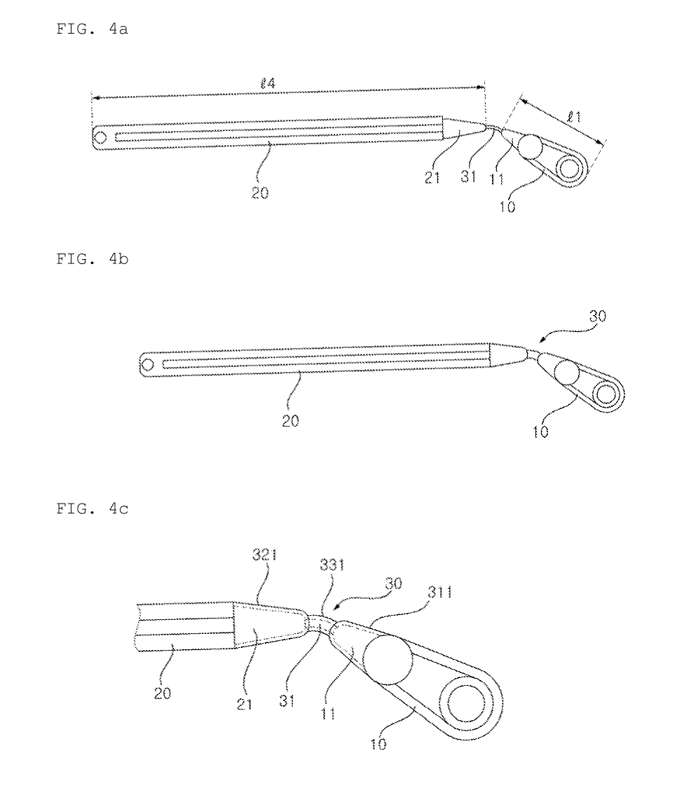

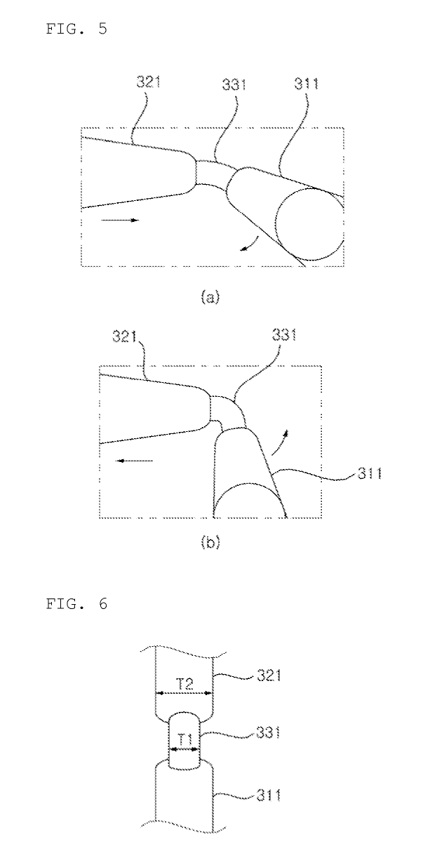

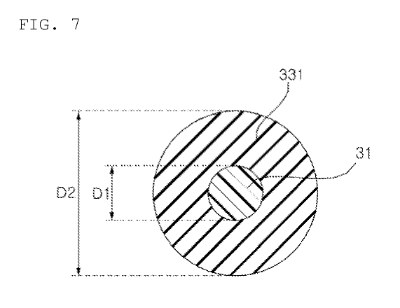

FIG. 3 is a front view illustrating an air vent device of a vehicle according to an exemplary embodiment of the present invention, FIGS. 4A and 4B are front views illustrating steps of manufacturing an operating member illustrated in FIG. 3, FIG. 4C is a partially enlarged view of FIG. 4B, FIG. 5 is an explanatory view illustrating operational states of the operating member illustrated in FIG. 3, FIG. 6 is a partially enlarged view of the operating member illustrated in FIG. 3, and FIG. 7 is an enlarged cross-sectional view taken along line A-A′ of FIG. 3.

Referring to FIGS. 3 to 7, an air vent device of a vehicle according to an exemplary embodiment of the present invention includes a damper door 1 which adjusts a flow rate of air that is supplied to the interior of the vehicle, a knob 4 which is operated by a user so as to adjust an opening and closing angle of the damper door 1, and an operating member which is connected between the damper door 1 and the knob 4.

The operating member includes a rod portion 20 which has one end portion connected to the knob 4, a link portion 10 which has one end portion connected to the damper door 1, and a connecting portion 31 which connects the rod portion 20 and the link portion 10.

The operating member is formed by injection molding of a synthetic resin, and the link portion 10, the rod portion 20, and the connecting portion 31 are integrally formed.

In addition, in the operating member, the connecting portion 31 is made of an elastic material so as to be bent or pivoted, a thickness of the connecting portion 31 may be smaller than those of the link portion 10 and the rod portion 20, and a cross section of the connecting portion 31 may be formed in a circular shape.

Meanwhile, the link portion 10 may be rotatably connected to the damper door 1 like the link in the related art, and the rod portion 20 may be connected to the knob 4 so as to be linearly movable like the rod in the related art.

The one side portion 11 of the link portion 10, which is connected to the connecting portion 31, may be formed to have a thickness that is gradually decreased toward the connecting portion 31, and the one side portion 21 of the rod portion 20, which is connected to the connecting portion 31, may also be formed to have a thickness that is gradually decreased toward the connecting portion 31.

In addition, a length l1 of the link portion may be ten times greater than a length of the connecting portion 31, and a length l4 of the rod portion may be greater than a length of the link portion.

Meanwhile, the connecting portion 31 is coated with an elastic member 30 obtained by insert injection molding using an elastic material such as rubber. Therefore, by the elastic member 30, elastic force of the connecting portion 31 is increased, and the connecting portion 31 is reinforced.

In addition to the connecting portion 31, the elastic member 30 may be coated on the one side portion 11 of the link portion and the one side portion 21 of the rod portion by insert injection molding, a portion of the one side portion 311 of the link portion, which is coated with the elastic member 30 and disposed to be opposite to the connecting portion 31, may have a thickness the same as that of the adjacent link portion 10 so as not to form a level difference with a surface of the adjacent link portion 10, and a portion of the one side portion 321 of the rod portion, which is coated with the elastic member 30 and disposed to be opposite to the connecting portion 31, may also have a thickness the same as that of the adjacent rod portion 20 so as not to form a level difference with a surface of the adjacent rod portion 20.

As illustrated in FIG. 7, a thickness or a diameter D2 of the connecting portion 331, which is coated with the elastic member, may be three times greater than a thickness or a diameter D1 of the connecting portion 31 which is not coated with the elastic member.

As illustrated in FIG. 6, a width T2 in front and rear directions of the one side portion 311 of the link portion and/or the one side portion 321 of the rod portion, which are coated with the elastic member, may be twice greater than a width T1 in the front and rear directions of the connecting portion 331 that is coated with the elastic member.

According to the air vent device of a vehicle according to the exemplary embodiment of the present invention, which is configured as described above, as illustrated in FIGS. 3 and 5, when the knob 4 is rotated clockwise by the user, the rod portion 20 having the one side portion 321 is moved to the right side, the connecting portion 331 is bent clockwise, the link portion 10 having the one side portion 311 coated with a synthetic resin is rotated clockwise, and the damper door 1 connected to one end portion of the link portion 10 is also rotated clockwise, thereby adjusting an opening and closing angle of the damper door.

In this state, when the knob 4 is rotated counterclockwise by the user, the rod portion 20 having the one side portion 321 is moved to the left side, the connecting portion 331 is unfolded, the link portion 10 having the one side portion 311 is rotated counterclockwise, and the damper door 1 is also rotated counterclockwise, thereby adjusting an opening and closing angle of the damper door.

Therefore, a flow rate of air, which is discharged to the interior of the vehicle, is adjusted by the damper door 1.

While the exemplary embodiments of the present invention have been illustrated and described above, the present invention is not limited to the aforementioned specific exemplary embodiments, various modifications may be made by a person with ordinary skill in the technical field to which the present invention pertains without departing from the subject matters of the present invention that are claimed in the claims, and these modifications should not be appreciated individually from the technical spirit or prospect of the present invention.

What is claimed is:

1. An air vent device of a vehicle, comprising:
a damper door which adjusts a flow rate of air that is supplied to the interior of the vehicle;
a knob which is provided to operate the damper door; and
an operating member which connects the damper door and the knob,
wherein the operating member includes:
a link portion connected to the damper door;
a rod portion connected to the knob; and
a connecting portion which is connected between the link portion and the rod portion, and is formed to be bent or rotated,
wherein the link portion, the rod portion, and the connecting portion are integrally formed by injection molding.

2. The air vent device of claim 1, wherein the connecting portion is coated with an elastic member.

3. The air vent device of claim 2, wherein the elastic member is coated on the connecting portion, and one side portion of the link portion and/or one side portion of the rod portion, which are connected to the connecting portion.

4. The air vent device of claim 3, wherein a thickness of the one side portion of the link portion and/or a thickness of the one side portion of the rod portion is gradually decreased toward the connecting portion.

5. The air vent device of claim 4, wherein a portion of the one side portion of the rod portion, which is coated with a synthetic resin and disposed to be opposite to the connecting portion, has a thickness the same as a thickness of the adjacent rod portion.

6. The air vent device of claim 4, wherein a portion of the one side portion of the link portion, which is coated with a synthetic resin and disposed to be opposite to the connecting portion, has a thickness the same as a thickness of the adjacent link portion.

7. The air vent device of claim 3, wherein a width in front and rear directions of the connecting portion, which is coated with a synthetic resin, is smaller than a width in the front and rear directions of the one side portion which is coated with a synthetic resin.

8. The air vent device of claim 7, wherein a width in the front and rear directions of the connecting portion, which is coated with a synthetic resin, is a half of a width in the front and rear direction of the one side portion which is coated with a synthetic resin.

9. The air vent device of claim 1, wherein a cross section of the connecting portion is formed in a circular shape.

10. The air vent device of claim 1, wherein a thickness of the connecting portion is smaller than thicknesses of the link portion and the rod portion.

11. The air vent device of claim 1, wherein the link portion is longer than the connecting portion, and
the rod portion is longer than the link portion.
